(19) United States
(12) Patent Application Publication
(10) Pub. No.: US 2005/0155933 A1
(43) Pub. Date: Jul. 21, 2005

(54) Wallless monolith columns for chromatography

(75) Inventor: Qi-Feng Ma, Rancho Palos Verdes, CA (US)

Correspondence Address: Qi-Feng Ma;Archidex, Suite 101, 2311 West 205 th Street, Torrance, CA, 90501, US

(73) Assignee: Archidex

(21) Appl. No.: 11/031,495

(22) Filed: Jan. 7, 2005

Related U.S. Application Data
(60) Provisional application No. 60/537,066, filed on Jan. 16, 2004.

(51) Int. Cl. C02F 1/28

(52) U.S. Cl. 210/656

(57) ABSTRACT

A monolith column for chromatography comprising a monolith rod encased with a tubular structure wherein the mass of the interior surface layer of said tubular structure intercalate by an encasing process into the surface layer of said monolith rod through the micro-cavities of said surface layer of said monolith rod, forming a hybrid layer shared by both said monolith rod and said tubular structure.

### PRIORITY CLAIM

This application claims benefit of priority of U.S. Provisional Application Ser. No. 60/537,066 filed on Jan. 16, 2004 titled “Wallless Monolith Columns For Chromatography”.

### FIELD OF THE INVENTION

The present invention relates to a monolithic column for liquid chromatography.

### BACKGROUND

A monolith column refers to a continuous porous rod for chromatographic separation. The rod is cladded in a tube to guide fluid flow. For separation, the rod should be tightly cladded by the tube so that there would be no space in-between the exterior of the rod and the interior of the tube. In one prior art, the rod is inserted in a heat-shrinkable plastic tube that wraps the rod by heating (H. Minakuchi et al. J. Chromatography. A 762 (1997) 135-146). Though the process minimizes the space in-between the tube and the rod, the space has not been eliminated. FIG. 1 illustrates the structure of a monolith column of the prior art. The column contains a tube 10, a monolith rod 20, and a junction 11 in-between the rod and the tube. The magnified section shows irregular spaces at junction 11 of the monolith column of the prior art.

U.S. patent application Ser. No. 20030098279 describes encasing a monolith rod by fiber-reinforced plastic coating. Claim 1 of the patent application specifies a “Monolithic moulding which is encased with a fibre-reinforced thermoplastic leaving just a small dead space . . . ”. The application leads to a commercialized silica monolith column by Merck GMDH with a brand name of “Chromolith”. Although the encasing of thermoplastic on to the monolith rod is tight, it still leaves “just a small dead space” at the junction of the thermoplastic wrap and the monolith rod.

The dead spaces in-between the tube and the rod cause uneven fluid flow in the monolith column of the prior art. A fluid flows faster at the intersection between the rod and the tube, resulting in “wall effect”. When a mixture is separated in the column, it is eluted into bands of funnel shape by the influence of wall effect, severely affecting the resolution.

Several factors cause inferior cladding. On the surface of a monolith rod, there are many tiny cavities and is not flat microscopically. However, the interior surface of a cladding tube is microscopically flat even in the case of heat-shrinkable tubes. The tiny cavities on the exterior of the rod form dead spaces after being cladded into a microscopically flat tube. The dimensions of the rod are not absolutely exact in terms of straightness and diameters and any change in the dimensions will produce dead space around the wall. The cladding tightness is another factor for the wall effect. If the cladding is too tight, the rod will be crashed. If the cladding is loose, the wall dead space will be larger. It is very difficult to control the cladding process for making a monolith column.

It is ideal to have a monolith column that has no dead space in-between the tube and the rod and no wall effects.

### DISCLOSURE OF THE INVENTION

The present invention provides a monolith column that has no dead space between the rod and the cladding tube. The interior of the cladding tube melts into the micro-pores and cavities in the surface of the rod, forming a wall integrated into the rod surface. Since the interior wall of the cladding tube and the exterior surface of the rod is the same, the column has no wall from the point of rod anatomy. Further dissection of the column shows that the rod material is permanently intercalated in the interior wall of the tube, a unique characteristic of the present invention.

The primary objective of the present invention is to provide a monolith chromatographic column that has no wall effect.

Another objective is to provide a monolith column that eliminates the dead space between the monolith rod and the cladding tube.

Another objective is to provide a technology that realizes these objectives.

### DESCRIPTION OF THE DRAWINGS

FIG. 1 is a truncated cross-sectional view illustrating a monolith column of the prior art.

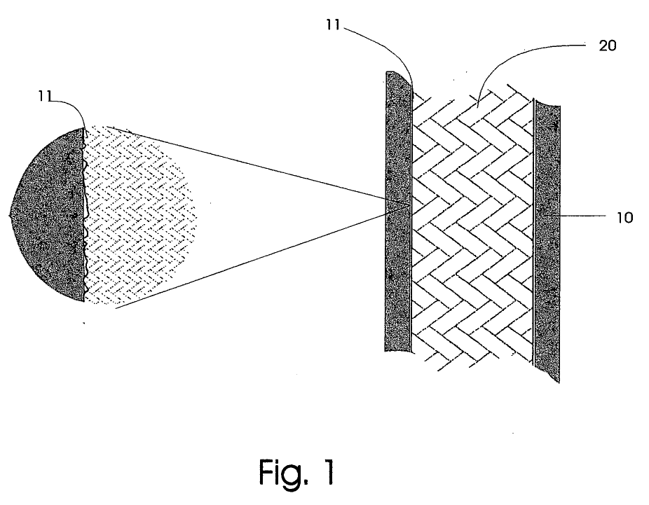

FIG. 2 is a truncated cross-sectional view illustrating a monolith column of the present invention.

FIG. 3a shows a process for making the monolith column of the present invention; FIG. 3b shows a finished monolith column made by a process illustrated in FIG. 3a.

FIG. 4a shows another process for making the monolith column of the present invention; FIG. 4b shows a finished monolith column made by a process illustrated in FIG. 4a.

### DETAILED DESCRIPTION OF THE PREFERRED EMBODIMENTS

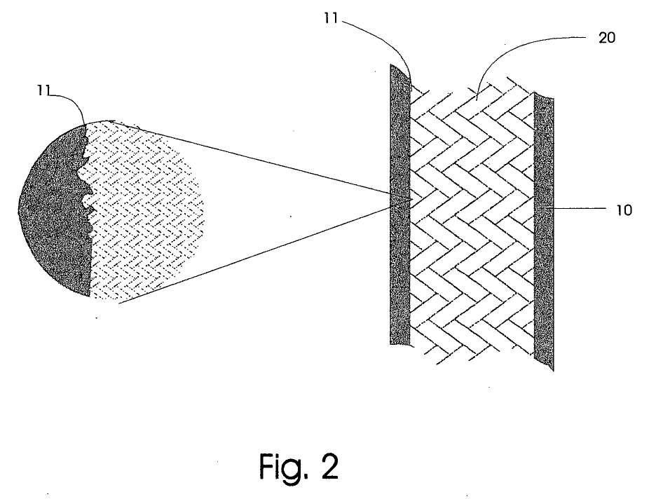

FIG. 2 illustrates the structure of the monolith column of the present invention. The monolith column comprises a tube 10, a porous monolith rod 20, and junction 11 between the tube and the monolith rod. To facilitate fluid flow in the column, end-fittings may be installed at the opposing ends (not shown in the Fig.). The magnified portion shows that the tube wall extends inwardly into the surface pores and cavities of the rod surface. Since the rod exterior and the tube interior share the same surface structure, there is no dead space in the junction 11. When a fluid flows through the column, the flow rate at the center of the rod is the same as that at the wall, eliminating the wall effect.

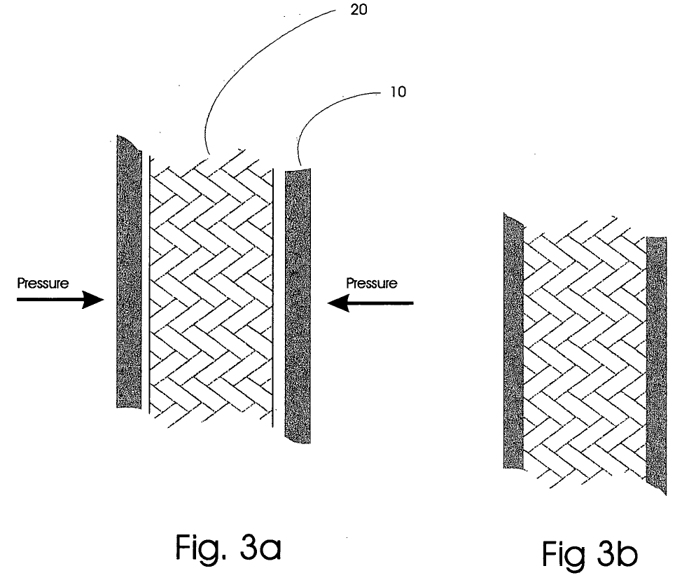

FIG. 3a shows a method for making the monolith column of the present invention. The process requires at least a monolith rod 20 and a tube 10. The monolith rod 20 is placed into tube 10 and the tube is radially compressed by any conventional means. The tube is then heated to a melting state. With the help of radial compression, the tube is gradually melted into the surface pores of the monolith rod. The tube is then cooled to ambient temperature. When the tube cools and restores its rigid structure, the radial compression is removed. A monolith column (FIG. 3b) with the characteristic of the embodiment shown in FIG. 2 is obtained.

The tube can be made of plastic, glass, or metal as long it can form a melting state. The monolith rod can be made of inorganic materials that include but are not restricted to aluminum oxide, titanium oxide, and silicon oxide. The monolith rod can also be formed by organic polymers that include but are not restricted to polymethacrylate, cellulose, polystyrene, polyacrylamide, agarose, polystyrene/divinylbenzene copolymer. The monolith rod can also be modified by any chemical reactions to introduce any functional groups to facilitate separation.

The radial compression can also be carried out by vacuum. Vacuum can be applied to the interior of the tube through both ends. It can also be applied through one end while the opposing end is sealed. The compression force should only be applied to the tube exterior, not the vacuum-connecting end. When other radial compression force is used in the process, the ends of the tube is preferred to be open for releasing air expansion during heating.

The monolith column produced in FIG. 3a can be further reinforced to increase the column strength. One method of the reinforcement is by press-fitting the monolith column shown in FIG. 3b into a stronger tube. The monolith column can also be placed into a stronger tube and fixed in the tube with a polymerizable liquid.

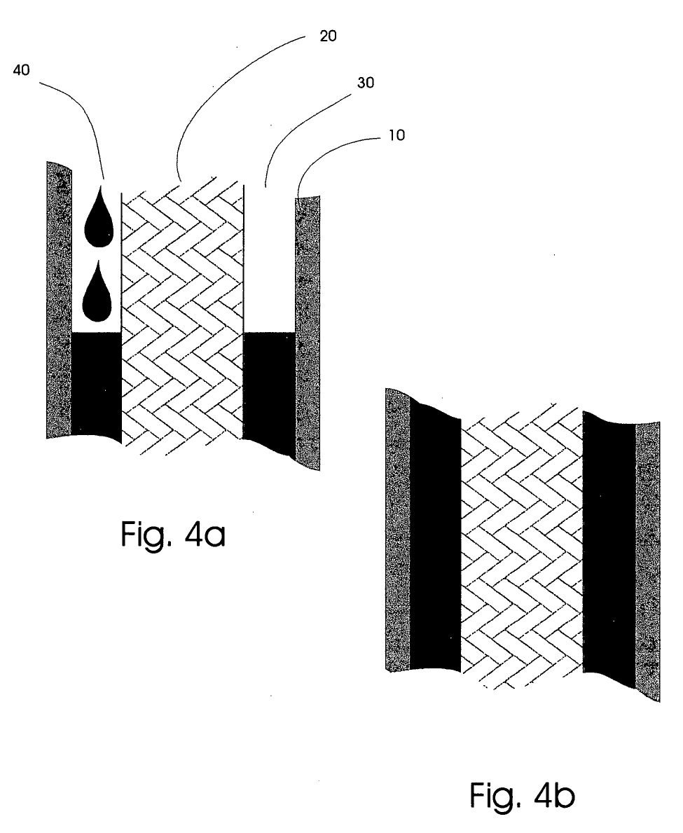

FIG. 4a shows a molding process to make a monolith column of the present invention. A monolith rod is placed in a rigid tube and coincides to the tube. A polymerizable fluid is filled into the space between the rod and the tube, forming a solid mass surrounding the monolith rod. For molding a dry monolith rod, a fluid of high viscosity should be used so that the fluid will not penetrate too deep into the rod. If a fluid of less viscosity is used, the monolith rod should be wet to a defined extent by a liquid immiscible with the polymerizable fluid before cladding.

Classical plastic molding process can also be used to make the monolith column of the present invention. A monolith rod is placed in the mold and molded with a melt plastic material. The column is formed after cooling.

The surface micro-pores or cavities of the monolith rod are permanently filled with the material of the cladding tube, a key unique feature that distinguishes the present invention from the prior art. In the monolith column of the prior art, the tube and the rod are physically separated, “leaving just a small dead space” as claimed by U.S. patent application Ser. No. 20030098279. After removing the rod away from the tube, the tube can be washed to remove all rod debits. In the monolith column of the present invention, the rod and the tube are physically integrated into one piece and the rod material on the interior surface of the tube is permanently fixed there and cannot be washed away. Since the interior wall of the tube has the same material and the same structure as the exterior surface of the rod, the monolith column of the present invention has no wall from chromatographic point. The interior surface of the tube and the exterior surface of the rod share the same structure and the dead space between the tube and the rod of the monolith column of the prior art is thus eliminated. The wall effect, one of the most problematic factors for degrading the monolith column performance, is eliminated by the present invention and a higher resolution is thus obtained for the monolith column of the present invention.

### EXAMPLE 1

A silica rod (2.8 mm×100 mm, OD×Length) was inserted into a polyethylene tube (0.32 mm×100 mm, ID×Length). One end of the tube was sealed and the other end was connected to a vacuum pump. After applying vacuum for 10 minutes, the tube was immersed into an oil bath of 140 degree Celsius and kept in the bath till the tube turned to melting state. The tube was then removed away from the bath and cooled to room temperature. The section containing silica monolith rod was cut into a column of 80 mm length and was tested for its structure and chromatographic behavior.

The cross section of the column showed that the rod was tightly surrounded by the tube and there were no dead spaces between the rod and the tube. When the rod material was removed from the tube and the tube was thoroughly washed, a thin layer of rod material still remained in the interior wall of the tube and could not be washed away, showing the rod exterior surface was permanently intercalated into the tubing wall.

The column was loaded with 1% Coomassie blue and eluted with 50% methanol to see the straightness of the dye band during chromatography. The band moved from the loading end to the opposing end and was straight, showing no wall effect in the monolith column.

### EXAMPLE 2

A silica rod (2.8 mm×100 mm, OD×Length) was inserted into a polyethylene tube (0.32 mm×100 mm, ID×Length). Both ends were connected to a vacuum pump and the rod was in the central section of the tube. After applying vacuum for 10 minutes, the section with the rod was immersed into an oil bath of 140 degree Celsius and kept in the bath till the tube turned to melting state. The tube was removed from the bath and cooled to room temperature. The section containing silica monolith rod was cut into a column of 80 mm length and was tested for its structure and chromatographic behavior.

The cross section of the column showed that the rod was tightly surrounded by the tube and there were no dead spaces between the rod and the tube. When the rod material was removed from the tube and the tube was thoroughly washed, a thin layer of rod material still remained in the interior wall of the tube and could not be washed away, showing the rod exterior surface was permanently intercalated into the tubing wall.

The column was loaded with 1% Coomassie blue and eluted with 50% methanol to see the straightness of the dye band during chromatography. The band moved from the loading end to the opposing end and was straight, showing no wall effect in the monolith column.

### EXAMPLE 3

A silica rod (2.8 mm×100 mm, OD×Length) was inserted into a polyethylene tube (0.32 mm×100 mm, ID×Length). The rod was in the central section of the tube. The tube sealed into a tubular chamber with both ends exposed to atmosphere. The tubular chamber was filled with oil and a 4-psi pressure was applied to the oil in the chamber. The oil bath was heated to 140 degree Celsius and kept at this temperature till the tube turned to melting state (about 5 minutes). The oil in the chamber was cooled to room temperature and the pressure to the oil was then released. The rod was cladded in the tube after the process. The section containing silica monolith rod was cut into a column of 80 mm length and was tested for its structure and chromatographic behavior.

The cross section of the column showed that the rod was tightly surrounded by the tube and there were no dead spaces between the rod and the tube. When the rod material was removed from the tube and the tube was thoroughly washed, a thin layer of rod material still remained in the interior wall of the tube and could not be washed away, showing the rod exterior surface was permanently intercalated into the tubing wall.

The column was loaded with 1% Coomassie blue and eluted with 50% methanol to see the straightness of the dye band during chromatography. The band moved from the loading end to the opposing end and was straight, showing no wall effect in the monolith column.

### EXAMPLE 4

The clad monolith column from example 1 was centrically placed in a stainless steel tube (0.5 inch×2 inch, internal diameter×length). The space between the stainless steel tube and the clad monolith column was filled with epoxy resin. After the epoxy resin solidified, the clad monolith column was cut flat to the ends of the stainless steel tube and the whole assembly was installed with two end-fittings in the same way as conventional chromatographic columns. A 2000-psi pressure was applied to the clad column and the tests were conducted as in example 1. The approach gave the same results as in example 1, showing a reinforced monolith column resisting high pressure while giving good results.

### EXAMPLE 5

A silica monolith rod (0.5 inch×3 inch, diameter×length) was centrically placed in a stainless steel tube (0.75 inch×2.5 inch, internal diameter×length). The space between the stainless steel tube and the silica rod was filled with epoxy resin. After the epoxy resin solidified, the molded monolith column was cut flat to the ends of the stainless tube and the tests were conducted as in example 1. The approach gave the same results as in example 1, showing the applicability of a molding process for making a monolith column of the present invention.

1. A monolith column for chromatography comprising a monolith rod encased within a tubular structure wherein the mass of the interior surface layer of said tubular structure intercalates by a encasing process into the surface layer of said monolith rod through the micro-cavities of said surface layer of said monolith rod, forming a hybrid layer shared by both said monolith rod and said tubular structure.

2. A monolith column of claim 1 wherein said monolith rod is made of inorganic materials, said inorganic materials including silica oxide, aluminum oxide, zirconium oxide, calcium phosphate and their modifications.

3. A monolith column of claim 1 wherein said monolith rod is made of organic materials, said organic materials including polymethacrylate, polystyrene-divinylbenzene copolymer, polysacchrides, polyacrylamide, polysiloxane, agarose, and their modifications.

4. A monolith column of claim 1 wherein said monolith rod is made of organic/inorganic hybrid materials.

5. A monolith column of claim 1 wherein said tubular structure is made of meltable materials, said meltable materials including plastics, glass, and metal.

6. A monolith column of claim 1 wherein said encasing process comprises:
1) inserting said monolith rod into said tubular structure;
2) applying an inward pressure onto the exterior of said tubular structure;
3) heating said tubular structure to melting state;
4) releasing pressure after said tubular structure cools down and solidifies.

7. A monolith column of claim 5 wherein said inward pressure is generated by applying vacuum to the interior of said tubular structure.

8. A monolith column of claim 1 wherein said monolith column is reinforced by:
1) inserting said monolith column into a rigid hollow structure;
2) adding a solidifiable liquid in-between said monolith column and said rigid hollow structure, said monolith column being molded within a solid mass after said solidifiable liquid solidifies.

9. A monolith column of claim 1 wherein said encasing process comprises:
1) inserting said monolith rod into a rigid hollow structure;
2) adding a solidifiable liquid in-between said monolith rod and said rigid hollow structure;
3) applying pressure onto said solidifiable liquid while said solidifiable liquid is solidifying;
4) releasing pressure after said solidifiable liquid turns to a solid mass.
